(19) United States
(12) Patent Application Publication
(10) Pub. No.: US 2004/0192260 A1
(43) Pub. Date: Sep. 30, 2004

(54) Data backup system and data backup method, wearable computer, mail transmission system, image-information transmission system, and data backup program

(75) Inventors: Fujikazu Sugimoto, Matsumoto-shi (JP); Yusuke Watanabe, Fujimi-cho (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/779,729

(22) Filed: Feb. 18, 2004

(30) Foreign Application Priority Data
Mar. 31, 2003 (JP) 2003-097507
Feb. 12, 2004 (JP) 2004-035102

(51) Int. Cl. H04Q 7/20

(52) U.S. Cl. 455/412.1

(57) ABSTRACT

To provide a wearable computer that allows a user to back up important data on a device immediately at hand for the user. A data backup system is provided including a wearable computer and a portable information terminal that carries out communication with the wearable computer, the portable information terminal reads the history of updates and backups from a storage device, compares the time of the last backup indicated by the backup history with the update history, and searches for data that has been newly updated since the time of the last backup. The portable information terminal extracts the newly updated data as backup data, and sends the extracted backup data. The wearable computer receives the backup data, and writes the backup data in the storage device.

### BACKGROUND OF THE INVENTION.

1. Field of Invention

The present invention relates to a wearable computer that can be applied to glasses, clothes, or the like, and that carries out various data communications with portable information terminals, such as cellular phones, PDAs, and the like, and to a data backup system, a data backup method, and a data backup program.

2. Description of Related Art

A communication device that is carried by a user and that carries out communication with another communication terminal, for example, an incoming-call alert machine that notifies a user of incoming calls to a cellular phone without errors, is disclosed in Japanese Unexamined Patent Application Publication No. 2000-295321.

According to this communication device, a cellular phone detects an incoming call, and outputs an incoming-call trigger signal to an incoming-call alert-signal transmitter. The incoming-call alert-signal transmitter generates an incoming-call alert signal with an identifier code attached thereto, and sends it by wireless transmission to an incoming-call alert-signal receiver. The incoming-call alert-signal receiver receives the incoming-call alert signal, and makes notification of the incoming call only when an identifier-code recognizer finds a match for the identifier code.

Also, a cellular phone in which the ease of operation is enhanced without compromising the portability of the cellular phone, is disclosed in Japanese Unexamined Patent Application Publication No. 7-143550.

This cellular phone has a detachable transceiver. The transceiver is detached from the main unit of the cellular phone when the cellular phone is carried by the user. The transceiver is placed, for example, in a pocket of clothes, and the main unit is carried, for example, in a bag. When an incoming call arrives, the transceiver notifies the user of the incoming call. When the cellular phone is used, the transceiver is attached to the main unit of the cellular phone.

Also, a cellular phone that is capable of notification of incoming calls while preventing the incoming calls from bothering people nearby and accurately making notification of the incoming calls, is disclosed in Japanese Unexamined Patent Application Publication No. 11-318540.

According to this cellular phone, a vibrator that vibrates when it receives an electromagnetic wave generated by the cellular phone receiving an incoming call is placed in a portion of a bag carried by the user, so that the vibration will be transmitted to the body of the user.

Due to the increase in the density of pixels, of dot-matrix liquid crystal displays, display of an image on a small screen with a high definition is possible on devices that are carried by users and that carry out communications with other information terminals, such as those described above.

Specifically, according to Japanese Unexamined Patent Application Publication No. 2001-100187, transistors, reflection electrodes connected to the transistor, and an interlayer insulating film under the reflection electrode are provided on a substrate. The interlayer insulating film includes a first silicon oxide film, a second silicon oxide film formed on the first silicon oxide film by polycondensation of a silicon compound and hydrogen peroxide, and a third silicon oxide film formed on the second silicon oxide film. Accordingly, a reflection liquid crystal panel in which the reflection electrode has optimal reflection characteristics is provided, allowing high-quality reflection display with a wide viewing angle and a high brightness.

### SUMMARY OF THE INVENTION

Phone-number data of a cellular phone is sometimes backed up on a personal computer or the like. However, if original data becomes corrupted at a place away from home or office, the original data can be recovered only through the personal computer where the data has been backed up. This is troublesome in case of an emergency.

Furthermore, when an image captured by a camera of a cellular phone is to be viewed, the image is usually displayed on a display of the cellular phone. Thus, in a situation where the cellular phone cannot be pulled out, the image cannot be viewed. This problem also applies to e-mail. That is, in a situation where the cellular phone cannot be pulled out or where the cellular phone must be turned off, mail cannot be created or viewed.

The present invention has been made in view of the situation described above. The present invention provides a wearable computer, a data backup system and a data backup method, and a data backup program that allow a user to back up important data on a device immediately at hand for the user.

The present invention also provides a wearable computer, a data backup system and a data backup method, and a data backup program that allow a user to create or view image data or mail data on a device immediately at the user's disposal without connection through a portable information terminal.

The present invention has been made in order to address the problems described above. A data backup system according to an aspect of the present invention includes a wearable computer; and a portable information terminal that carries out data communication with the wearable computer; the portable information terminal including a first storage device to store predetermined data, a history of updates of the data, and a history of backups of the data; and a reading device to read the update history and the backup history from the first storage device, compare the time of the last backup indicated by the backup history with the time of the last update indicated by the update history, search for data newly updated since the time of the last backup, extract the newly updated data as backup data, and send the backup data extracted; and the wearable computer including a receiving device to receive the backup data; and backup-data writing device to write the backup data to second storage device.

In the data backup system according to an aspect of the present invention, the portable information terminal may include a data compressing device to compress the backup data, and a sending device to send the compressed backup data. The wearable computer may include a data expanding device to expand the compressed backup data received by the receiving device.

In the data backup system according to an aspect of the present invention, the predetermined data and the backup data each includes an identifier representing the predetermined data, and the backup-data writing device compares the identifier of backup data stored in advance in the second storage device with the identifier of the backup data received, and writes the backup data received to the second storage device when these identifiers coincide with each other.

In the data backup system according to an aspect of the present invention, the first storage device may further stores in advance a predetermined communication identifier, the sending device sends a communication-connection request using the communication identifier, and the wearable computer further includes an authenticating device to compare the communication identifier received by the receiving device with the communication identifier stored in advance in the second storage device, and permitting connection by the portable information terminal when these identifiers coincide with each other.

A computer according to an aspect of the present invention is a wearable computer that carries out data communication with a portable information terminal, the wearable computer including a first receiving device to receive the communication identifier of the portable information terminal from the,portable information terminal; an authenticating device to compare the communication identifier received with the communication identifier stored in advance in a predetermined storage device, and permitting connection, by the portable information terminal when these identifiers coincide with each other; a second receiving device to receive backup data from the portable information terminal when connection has been permitted by the authenticating device;, and a backup-data writing device to write the backup data in the storage device.

A mail transmission system according to an aspect of the present invention includes a wearable computer; and a portable information terminal that carries out data communication with the wearable computer; the wearable computer including an input device to receive input of mail information; a data compressing device to compress the mail information that has been input; and a first sending device to send the compressed mail information to the portable information terminal; and the portable information terminal including a receiving device to receive the compressed mail information; a data expanding device to expand the compressed mail information received; and a second sending device to send the expanded mail information to the destination address indicated by the mail information.

An image-information transmission system according to an aspect of the present invention includes a wearable computer; and a portable information terminal that carries out data communication with the wearable computer; the wearable computer including an input device to receive input specifying image data to be transmitted; a data compressing device to compress the image data if the amount of the image data specified is greater than or equal to a predetermined threshold; and a sending device to send the compressed image data; and the portable information terminal including a receiving device to receive the compressed image data; a data expanding device to expand the compressed image data received; and an image-data writing device to write the expanded image data to a predetermined storage, device.

An image-information transmission system according to an aspect of the present invention includes a wearable computer; and a portable information terminal that carries out data communication with the wearable computer; the portable information terminal including an input device to receive input specifying image data to be transmitted; a data compressing device to compress the image data if the amount of the image data specified is greater than or equal to a predetermined threshold; and a sending device to send the compressed image data; and the portable information terminal including a receiving device to receive the compressed image data and an image-data writing device to write the compressed image data in a predetermined storage device.

A data backup method according to an aspect of the present invention is a method to back up data in a data backup system including a wearable computer and a portable information terminal that carries out data communication with the wearable computer, the portable information terminal, from a first storage device stores predetermined data, the history of updates of the data, and the history of backups of the predetermined data, reads the update history and the backup history, compares the time of the last backup indicated by the backup history with the time of the last update indicated by the update history, searches for data newly updated since the time of the last backup, extracts the newly updated data as backup data, and sends the backup data extracted, and the wearable computer receives the backup data, and writes the backup data to a second storage device.

A data backup program according to an aspect of the present invention is a program to allow a wearable computer to execute a data backup process of backing up data in a data backup system including the wearable computer and a portable information terminal that carries out data communication with the wearable computer, the data backup process including a receiving process of receiving a communication identifier of the portable information terminal from the portable information terminal; an authenticating process of comparing the communication identifier received with a communication identifier stored in advance in a predetermined storage device, and permitting connection by the portable information terminal when these identifiers coincide with each other; a receiving process of receiving backup data from the portable information terminal when connection has been permitted in the authenticating process; and a backup-data writing process of writing the backup data to the storage device.

### BRIEF DESCRIPTION OF THE DRAWINGS

FIG. 1 is a block schematic showing the configuration of a wearable computer according to an exemplary embodiment;

FIG. 2 is an illustration showing the exterior of a wearable computer that is worn on a sleeve of clothes such as a suit;

FIG. 3 is a block schematic showing the configuration of a portable information terminal according to an exemplary embodiment;

FIG. 4 is a flowchart showing the procedure of an authentication process executed between the wearable computer and the portable information terminal according to an exemplary embodiment;

FIG. 5 is a flowchart showing the procedure of a communication process that takes place during a data backup;

FIG. 6 is a schematic showing the data structure of a phone-number table stored in the portable information terminal;

FIG. 7 is a flowchart showing the procedure of a communication process that takes place during a data backup;

FIG. 8 is a schematic showing how updated data is searched for over the phone-number table stored in the portable information terminal;

FIG. 9 is a schematic showing a phone-number table including updated data;

FIG. 10 is a schematic showing the phone-number table with data representing update date/time D deleted therefrom;

FIG. 11 is a flowchart showing the procedure of a communication process that takes place during a data backup;

FIG. 12 is a schematic showing the data structure of a phone-number table stored in the wearable computer;

FIG. 13 is a schematic showing the data structure of the phone-number table stored in the wearable computer after it has been updated;

FIG. 14 is a flowchart showing the procedure of a communication process that takes place during a data backup;

FIG. 15 is a flowchart showing the procedure of a communication process that takes place during a data backup;

FIG. 16 is a flowchart showing the procedure of a communication process that takes place during a data backup;

FIG. 17 is a schematic showing the data structure of backup data received from the wearable computer;

FIG. 18 is a schematic showing the data structure of a phone-number table stored in the portable information terminal;

FIG. 19 is a schematic showing the data structure of the phone-number table stored in the portable information terminal after it has been updated;

FIG. 20 is a flowchart showing the procedure of an image-information transmission process;

FIG. 21 is a flowchart showing the procedure of the image-information transmission process;

FIG. 22 is a flowchart showing the procedure of a mail transmission process;

FIG. 23 is an illustration showing the exterior of a wearable computer integrated with glasses;

FIG. 24 is an illustration showing the exterior of a wearable computer that is detachable from glasses; and

FIG. 25 is an illustration showing a display panel detached from a wearable computer.

### DETAILED DESCRIPTION OF EXEMPLARY EMBODIMENTS

A wearable computer according to an aspect of the present invention is a computer that can be mounted on a certain object, such as a computer that is detachable from or wearable on a human body. Hereinafter in this specification, a computer that can be mounted will be referred to as a “wearable computer”.

A data backup system including a wearable computer and a portable information terminal according to an aspect of the present invention will be described with reference to the drawings.

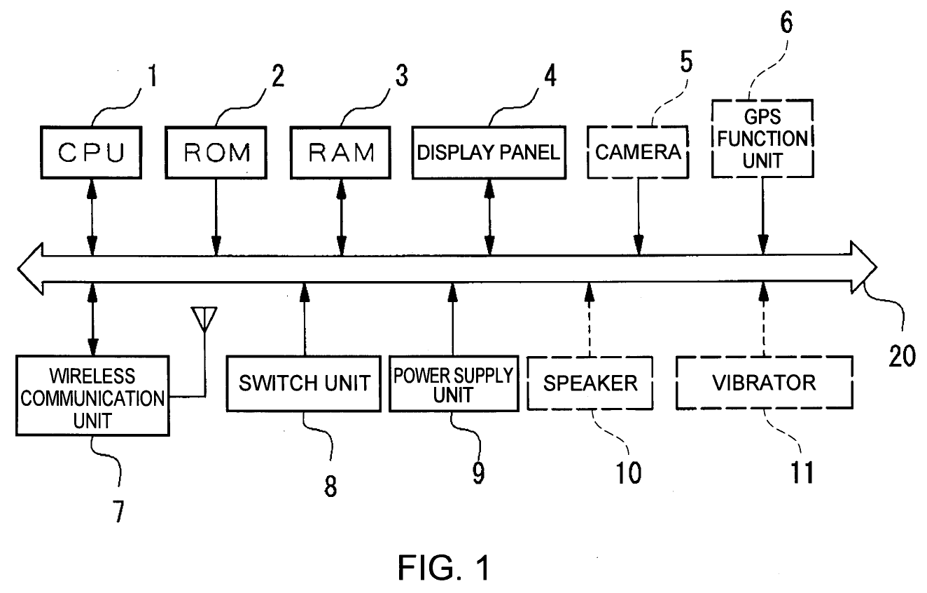

FIG. 1 is a schematic showing the configuration of the wearable computer according to an exemplary embodiment.

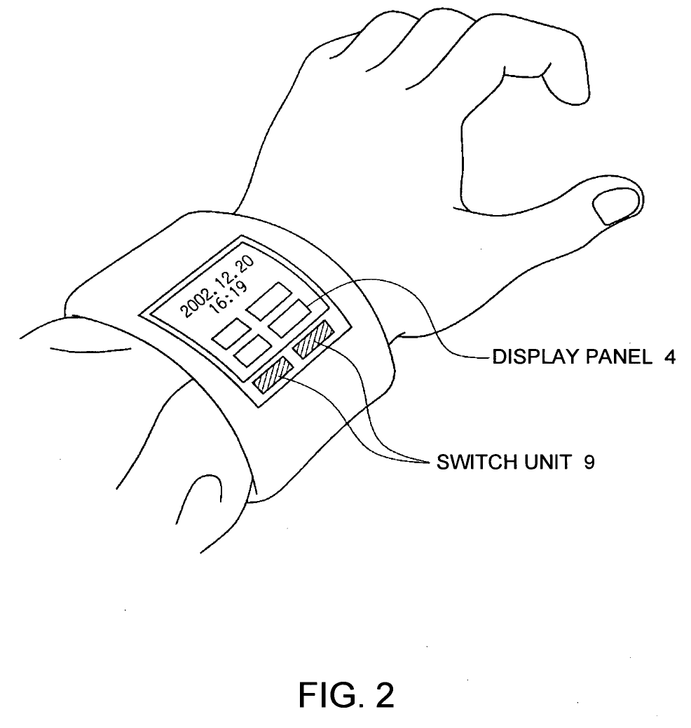

The wearable computer according to this exemplary embodiment can be applied to a watch, glasses, a pendant, a ring, a hat, a bracelet, clothes, or the like. This exemplary embodiment will be described in the context of an example where the wearable computer is worn on a sleeve of clothes, such as a suit, as shown in FIG. 2.

The wearable computer according to this exemplary embodiment includes a CPU 1, a ROM 2, a RAM 3, a display panel 4, a camera 5, a GPS unit 6, a wireless communication unit 7, a switch unit 8, a power supply unit 9, a speaker 10, and a vibrator 11, these components being connected to each other via a bus 20.

The CPU 1 is a central processing unit that reads programs stored in the ROM 2, writes the programs to the RAM 3, and executes the programs, thereby controlling the components and executing data calculation and processing.

The ROM 2 is a ROM that is electrically erasable (rewritable), such as a flash memory, and it stores in advance later-described control programs and parameters for the CPU, in particular a data backup program.

The RAM 3 is a work memory for the CPU, and it is a semiconductor memory that allows reading from and writing to an arbitrarily specified address.

The display panel 4 serves as a display for the wearable computer according to this exemplary embodiment, and includes a dot-matrix liquid crystal display panel.

The camera 5 is an imager that captures an image of an object to which the wearable computer is directed by the user, in response to input of a certain imaging command.

The GPS function unit 6 carries out communication with GPS satellites to calculate a current position of the wearable computer, and executes, in cooperation with a navigation system, a display process in which map information stored in advance is associated with current position information.

A wireless communication unit 7 carries out data communication with a wireless communication unit (which will be described later) provided in the portable information terminal, via a wireless LAN connection or a WPAN (wireless personal area network) connection. The wireless communication unit 7 connects to an external network, such as the Internet and carries out data communication.

The switch unit 8 is an operation unit that allows the user to perform operations, such as a display selection on the wearable computer, and more specifically, it includes a plurality of switches.

The power supply unit 9 is implemented by a chargeable battery that generates electric power and recharges itself by automatic winding when the user swings his/her arm.

The speaker 10 is an audio output unit that outputs a ringtone, an alarm, and the like.

The vibrator 11 vibrates the wearable computer in response to input of a specified vibration command.

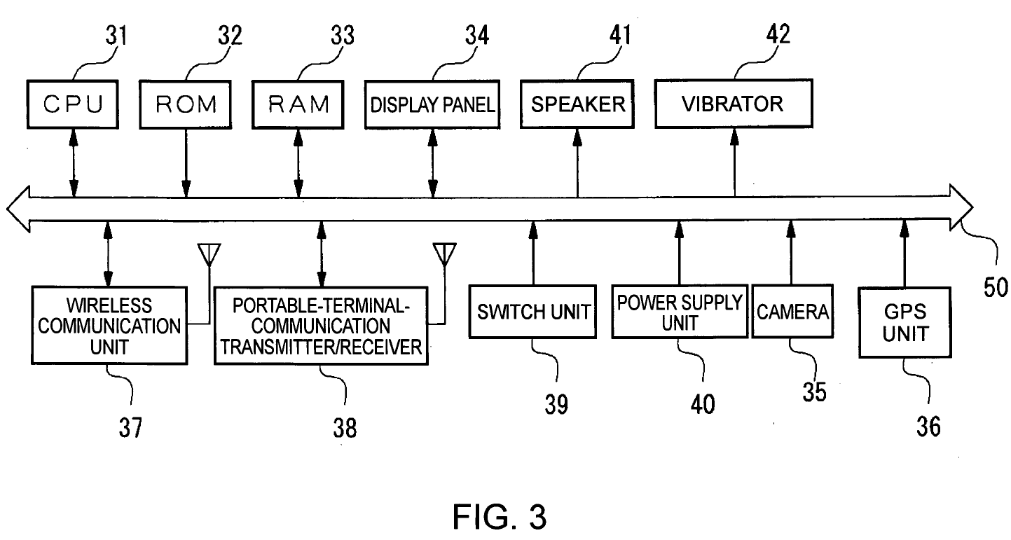

FIG. 3 is a schematic showing the configuration of a portable information terminal according to this exemplary embodiment.

The portable information terminal according to this exemplary embodiment can be applied to a cellular phone, a PDA, a portable PC, and the like. This exemplary embodiment will be described in the context of an example where the portable information terminal is a cellular phone.

The portable information terminal according to this exemplary embodiment includes a CPU 31, a ROM 32, a RAM 33, a display panel 34, a camera 35, a GPS function unit 36, a wireless communication unit 37, a portable-terminal-communication transmitter/receiver 38, a switch unit 39, a power supply unit 40, a speaker 41, and a vibrator 42, these components being connected to each other via a bus 50.

The CPU 31 is a central processing unit that reads programs stored in the ROM 32, writes the programs in the RAM 33, and executes the programs, thereby controlling the components and executing data calculations and processing. More specifically, for example, the ROM 32 stores cellular-phone-number data, mail-address data, and the history of updates and backups of these data that have been made, and the CPU 31 reads the update history and the backup history from the ROM 32, compares the time of the last backup indicated by the backup history with the update history, and searches for data newly updated since the time of the last backup. The newly updated data is extracted as backup data, and processing to send the backup data extracted and other related processes are executed.

A ROM 32 is, for example, a read-only mask ROM, or an electrically erasable (rewritable) ROM, such as a flash memory. The ROM 32 stores in advance programs and parameters for the CPU, cellular-phone-number data, mail-address data, and the update history and backup history of these data.

The RAM 33 is the work memory for the CPU, and it is a semiconductor memory that allows reading from and writing at an arbitrarily specified address.

The display panel 34 serves as a display of the portable information terminal according to this exemplary embodiment, and is implemented by a dot-matrix liquid crystal display panel.

The camera 35 is an imager to capture an image of an object to which the portable information terminal is directed by the user, in response to input of a predetermined imaging command.

The GPS function unit 36 carries out communication with GPS satellites to calculate the current position of the wearable computer, and executes, in cooperation with a navigation system, a display process in which map information stored in advance is associated with current position information.

The wireless communication unit 37 carries out data communication with the wireless communication unit provided in the wearable computer, via a wireless LAN connection or a WPAN (wireless personal area network) connection.

The cellular-phone-communication transmitter/receiver 38 carries out audio communication, and connects to an external network to carry out data communication.

The switch unit 39 is an operation unit that allows the user to perform operations, such as a display selection on the portable information terminal, and more specifically, it includes a plurality of switches.

The power supply unit 40 is implemented by a chargeable battery, and it may be set on a cradle so that it is directly charged by a power supply kept at home.

The speaker 41 is an audio output unit that outputs sounds, such as a ringtone.

The vibrator 42 vibrates the portable information terminal in response to input of a predetermined vibration command.

Now, the operations of the wearable computer and the portable information terminal in the data backup system according to this exemplary embodiment will be described with reference to the drawings.

(1) Authentication and Data Backup

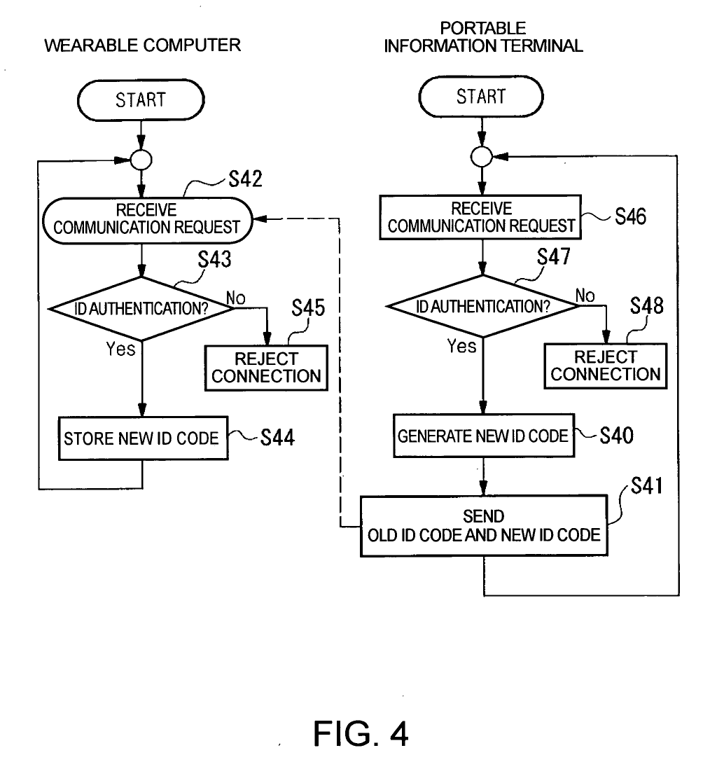

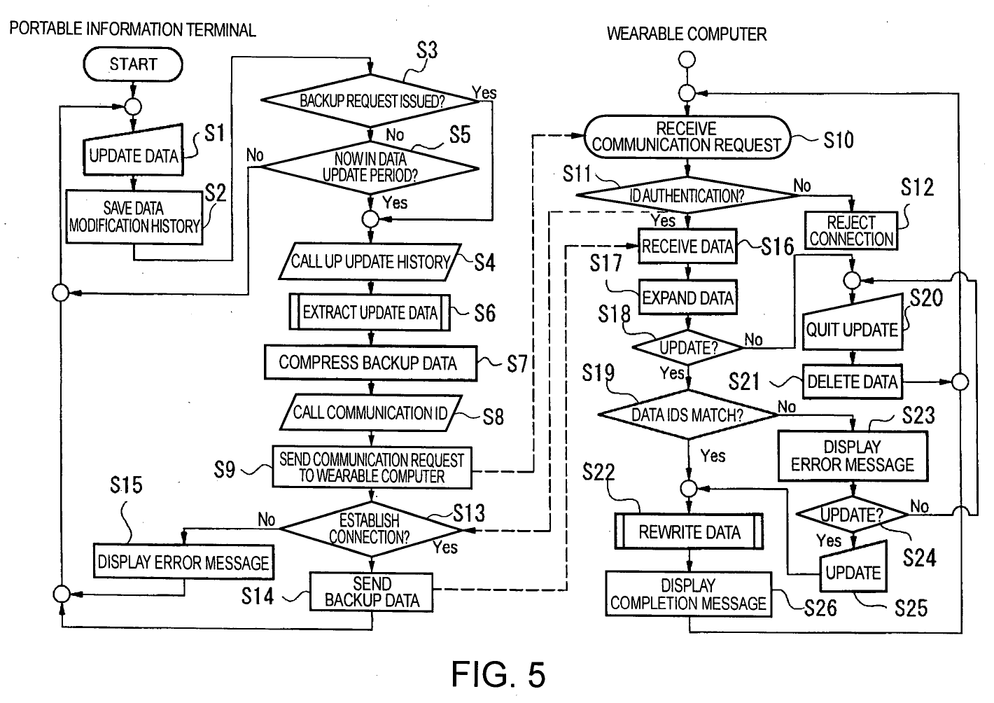

FIG. 4 is a flowchart showing an authentication process executed between the wearable computer and the portable information terminal according to this exemplary embodiment, and FIGS. 5 and 7 are flowcharts showing communication processes that take place during a data backup.

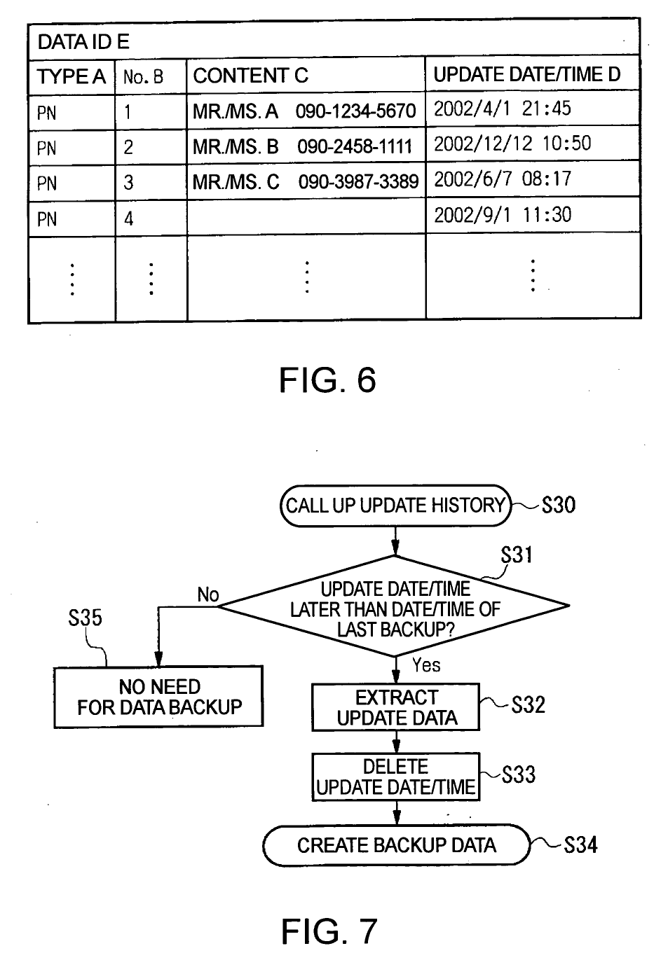

Let it be assumed that the user now operates (11:30 on Sep. 1, 2002) the switch unit 39 at the portable information terminal to delete content C at B: 4 (refer to a phone-number table shown in FIG. 6) and then rewrites content C at B: 2 (10:50 on Dec. 12, 2002). At this time, the CPU 31 updates the relevant sections (content C) of the phone-number table stored in advance in the ROM 32, shown in FIG. 6, according to inputs from the switch unit 39 (step S1 in FIG. 5), and updates data modification history (update date/time D).

After the data has been updated, at a cycle of a predetermined period (e.g., once a day, or once a month) indicated by a parameter stored in advance in the ROM 32, the CPU 31 executes a backup process for phone-number data and mail-address data in response to a trigger issued by a backup process being executed by the CPU 31 or input of a backup request issued by a user's operation of the switch unit 39.

More specifically, when a function to execute a backup process for the phone-number data or a function to execute a backup process for the mail-address data is selected in response to a user's operation of the switch unit 39 (Yes in step S3), the CPU 31 reads the update history from the ROM 32 (step S4),

Even when a backup request based on a user's operation has not been issued (No in step S3), when a trigger is issued at the data update time of the cycle of the predetermined period described above (Yes in step S5), the CPU 31 reads the update history from the ROM 32 (step S4, or step S30 in FIG. 7).

The CPU 31 further reads the backup history from the ROM 32, compares the time of the last backup indicated by the backup history with the update history, and searches for data with an update date/time that is later than the backup date/time of the last backup, i.e., data newly updated since the time of the last backup (e.g., Oct. 1, 2002) (step S31).

If newly updated data is found (Yes in step S31), the CPU 31 extracts the data as update data (i.e., backup data) (step S6 in FIG. 5, or step S32 in FIG. 7), deletes the update date/time D from the update data extracted (step S33), thereby creating backup data (step S34).

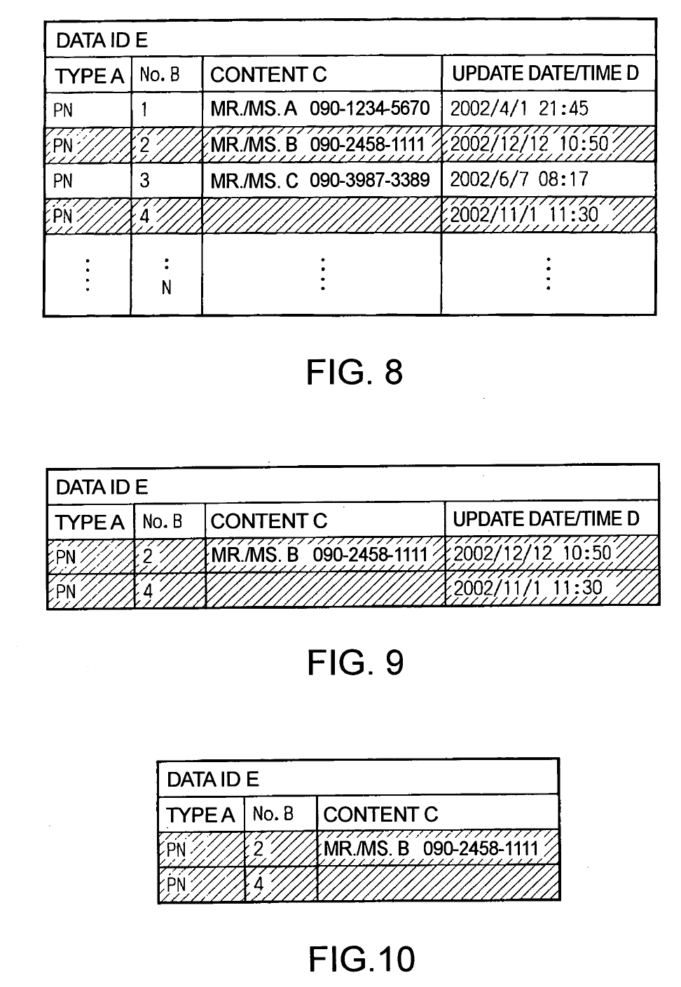

In this exemplary embodiment, data newly updated since the time of the last backup (Oct. 1, 2002) is at B: 2, 4 (refer to FIG. 8), so that the CPU 31 extracts this data (refer to FIG. 9), and deletes from them the update date/time D, thereby creating backup data (refer to FIG. 10).

However, if newly updated data is not found (No in step S31), update data does not exist, so that the CPU 31 may display on the display panel 34 a message indicating that there is no need for backup (step S35).

Upon creating the backup data, the CPU 31 compresses the backup data (step S7), and attaches to the compressed data a data ID (the same as data ID: E in the phone-number table shown in FIG. 6) that serves as an identifier of the backup data.

Then, the CPU 31 reads a communication ID (old ID code) that serves as a communication identifier, from the ROM 32 where it is stored in advance (step S8), and issues a communication request with the communication ID attached thereto to the wearable computer (step S9).

At this time, the CPU 31 creates a new ID code as a communication ID that is to be used in a next communication session with the wearable computer, and attaches the new ID code together with the old ID code to the communication request and sends the communication request through the wireless communication unit 37 (step S9 in FIG. 5, or step S41 in FIG. 4).

When the communication request from the portable information terminal has been received by the wearable computer through the wireless communication unit 7 (step S10 in FIG. 5, or step S42 in FIG. 4), the CPU 1 executes ID authentication. That is, the CPU 1 reads the communication ID stored in advance in the ROM 2, and checks whether the old ID attached to the communication request coincides with the communication ID (step S11 in FIG. 5, or step S43 in FIG. 4).

If these IDs match, the CPU 1 authenticates the wearable computer, sends a signal that permits establishment of a connection to the portable information terminal through the wireless communication unit 7, and writes the new ID code attached to the communication request to the ROM 2 (step S44 in FIG. 4).

However, if the communication ID and the old ID code do not match, the CPU 1 does not authenticate the wearable computer, and rejects connection (step S12 in FIG. 5).

When the connection-permitting signal from the wearable computer has been received by the portable information terminal through the wireless communication unit 37, a connection is established (Yes in step S13). Then, the CPU 31 sends backup data to the wearable computer through the wireless communication unit 37 (step S14).

However, if a connection-permitting signal is not received within a predetermined length of time (No in step S13), the CPU 31 displays on the display panel 34 an error message indicating a failure of connection (step S15).

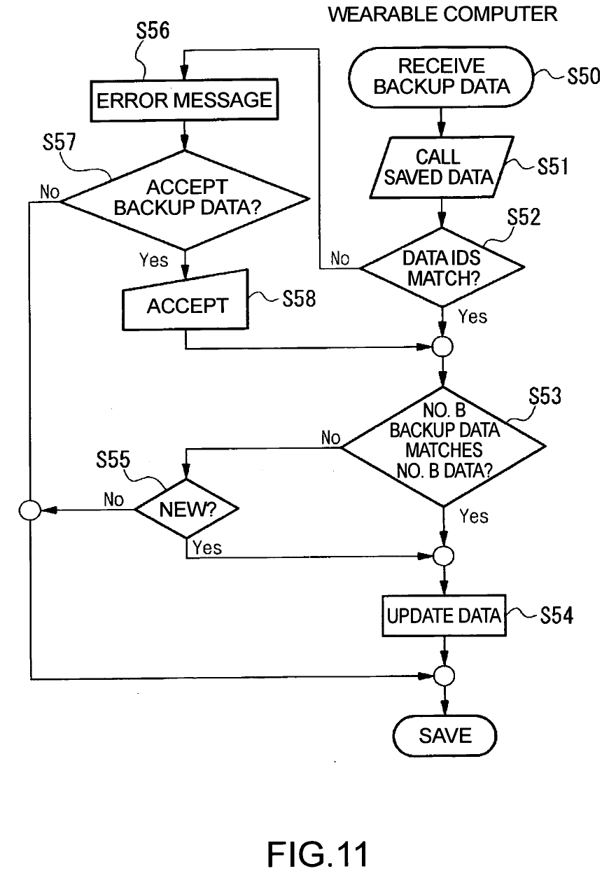

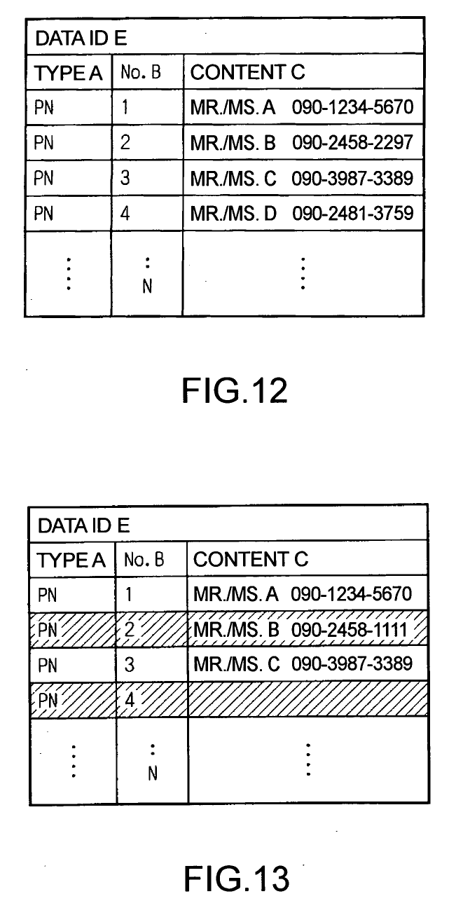

When the backup data from the portable information terminal has been received by the wearable computer through the wireless communication unit 7 (step S16 in FIG. 5, or step S50 in FIG. 11), the CPU 1 expands the backup data (step S17), and determines whether or not to update data based on the backup data (step S18). Specifically, if the completeness of the backup data is verified, for example, by a CRC check on the expanded data (Yes in step S18), the CPU 1 reads the phone-number table (refer to FIG. 12) stored in the ROM 2 (step S51 in FIG. 11), and checks whether the data ID of the backup data matches with data ID: E of the phone-number table (step S19 in FIG. 5, or step S52 in FIG. 11).

However, if the backup data has been corrupted, the CPU 1 quits the updating process (step S20), and erases and deletes the backup data (step S21).

If the data ID of the backup data matches the data ID in the phone-number table stored in the ROM 2 (Yes in step S52 in FIG. 11), the CPU 1 starts the data updating process. More specifically, the CPU 1 checks whether in No. B of the backup data there is a match in No. B of the phone-number table stored in the ROM 2. If a match is found (Yes in step S53), the CPU 1 overwrites the phone-number table in the ROM 2 using the backup data (step S22 in FIG. 5, or step S54 in FIG. 11).

In this exemplary embodiment, No. B: 2,4 in the phone-number table shown in FIG. 12 are overwritten using the backup data shown in FIG. 10. Thus, the content C of the phone-number table stored in the ROM 2 is rewritten as shown in FIG. 13.

However, if the data IDs do not match (No in step S19 shown in FIG. 5, No in step S52 shown in FIG. 11), the CPU 1 displays an error message on the display panel 4 (step S23 in FIG. 5, or step S55 in FIG. 11).

When the user operates the switch unit 8 to select acceptance of the backup data, the CPU 1, in response to the input of an accepting command from the switch unit 8 (Yes in step S24 in FIG. 5, or Yes in step S56 in FIG. 11), executes the same data processing as in the case where the data IDs match (steps S25 and S22 in FIG. 5 or steps S57, S53, S54 in FIG. 11).

However, when the user operates the switch unit 8 to select rejection of the backup data, the CPU 1, in response to the input of a rejecting command from the switch unit 8, does not execute the data updating process (No in step S24 in FIG. 5, S20 and S21, or No in step S56 in FIG. 11).

If in No. B of the backup data there is no match with the corresponding part of No. B of the phone-number table stored in the ROM 2 (No in step S53), the CPU 1 determines whether the backup data is new data comparing it with the No. B backup data (step S55). For example, if the No. B of the backup data is a new number, the CPU 1 uses the backup data to write new phone-number data in the phone-number table in the ROM 2 (step S22 in FIG. 5, or step S54 in FIG. 11).

When the data updating process described above has been completed, the CPU 1 displays a completion message on the display panel 4 (step S26).

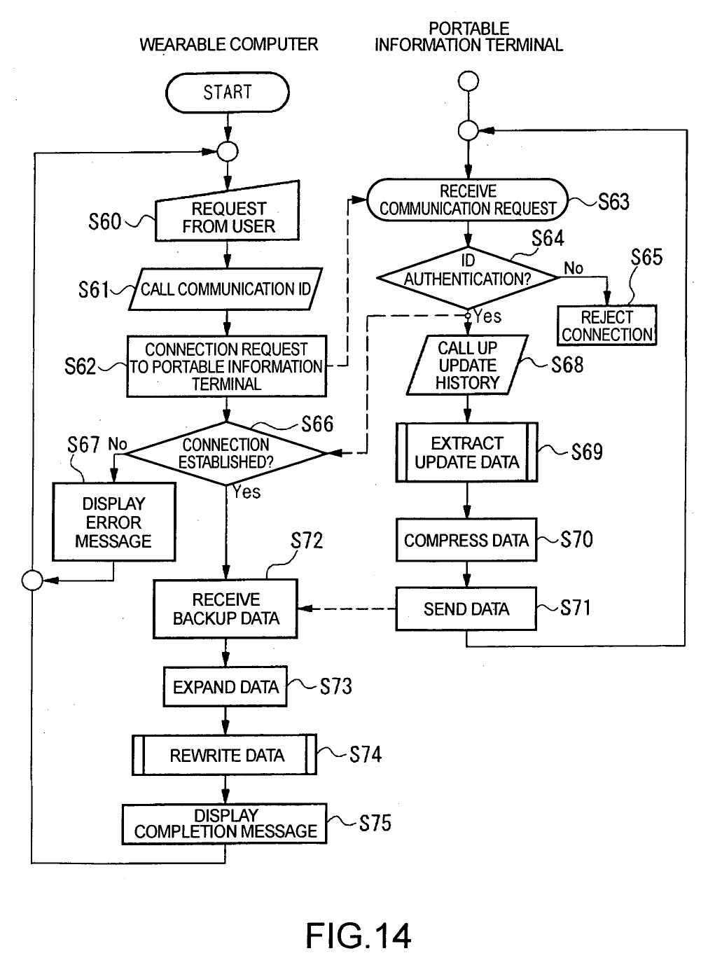

Next, the operations of the wearable computer and the portable information terminal in a case where the user operates the wearable computer to back up data in the portable information terminal will be described. FIG. 14 is a flowchart showing the communication process that takes place during a data backup between the wearable computer and the portable information terminal in this exemplary embodiment.

When the user operates the switch unit 8 of the wearable computer to select a function to execute backup of phone-number data or a function to execute backup of mail-address data, requesting start of a data backup process (step S60), the CPU 1 reads a communication ID (new ID code) that serves as a communication identifier from the ROM 2, and sends a communication request with the communication ID attached thereto to the portable information terminal (step S62).

When the communication request from the wearable computer has been received by the portable information terminal (step S63 in FIG. 14, or step S46 in FIG. 4), the CPU 31 executes ID) authentication. That is, the CPU 31 reads a communication ID stored in advance in the ROM 32, and checks whether the new ID code attached to the communication request coincides with the communication ID stored in advance (step S64 in FIG. 14, or step S47 in FIG. 4).

If these IDs match, the CPU 31 authenticates the wearable computer, and sends a signal that permits establishment of a connection to the wearable computer through the wireless communication unit 37.

However, if the communication ID and the new ID code do not match, the CPU 31 does not authenticate the portable information terminal, rejecting connection (step S65 in FIG. 14, or step S48 in FIG. 4).

When the connection-permitting signal from the portable information terminal has been received by the wearable computer through the wireless communication unit 7, the CPU 1 establishes a connection (Yes in step S66).

However, if a connection-permitting signal is not received within a predetermined length of time (No in step S66), the CPU 1 displays on the display panel 4 an error message indicating a failure of connection (step S67).

After the ID authentication, the CPU 31 starts a backup process for the phone-number data or the mail-address data. More specifically, the CPU 31 first reads an updating history from the ROM 32 (step S68). Then, the CPU 31 reads the backup history from the ROM 32, compares the time of the last backup indicated by the backup history with the updating history, and searches for data with an update date/time later than the date/time of the last backup, i.e., data newly updated since the time of the last backup. If newly updated data is found, the CPU 31 extracts it as update data (i.e., backup data) (step S69), and deletes the updating date/time D from the data to, be updated which has been extracted, thereby creating backup data.

However, if newly updated data does not exist, data to be updated does not exist, so that the CPU 31 may display on the display panel 34 a message indicating that no need for backup exists.

After creating the backup data, the CPU 31 compresses the backup data (step S70), and attaches a data ID that serves as an identifier of the backup data to the compressed backup data. Then, the CPU 31 generates a new ID code as a communication ID that is to be used for communication with the wearable computer, and attaches the new ID code as well as the old ID code to the backup data and sends it through the wireless communication unit 37 (step S71).

When the backup data from the portable information terminal has been received by the wearable computer through the wireless communication unit 7 (step S72), the CPU 1 expands the backup data (step S73), and determines whether or not to update data based on the backup data. More specifically, if the integrity of the backup data is verified, for example, by a CRC check on the expanded data, the CPU 1 reads the phone-number table or the mail-address table stored in the ROM 2, and determines whether the data ID of the backup data matches the data ID of the phone-number table or the mail-address table.

However, if the backup data is corrupted, the CPU 1 quits the updating process, and erases and deletes the backup data.

If the data ID of the backup data matches the data ID of the phone-number table or the mail-address table stored in the ROM 2, the CPU 1 starts the data updating process. More specifically, the CPU 1 checks whether in No. B of the backup data there is a match in No. B of the phone-number table or the mail-address table stored in the ROM 2. If a match is found, the CPU 1 overwrites the phone-number table or the mail-address table in the ROM 2 using the backup data (step S74 in FIG. 14).

However, if the data IDs do not match, the CPU 1 displays an error message on the display panel 4.

When the data updating process described above has been completed, the CPU 1 displays a completion message on the display panel 4 (step S75).

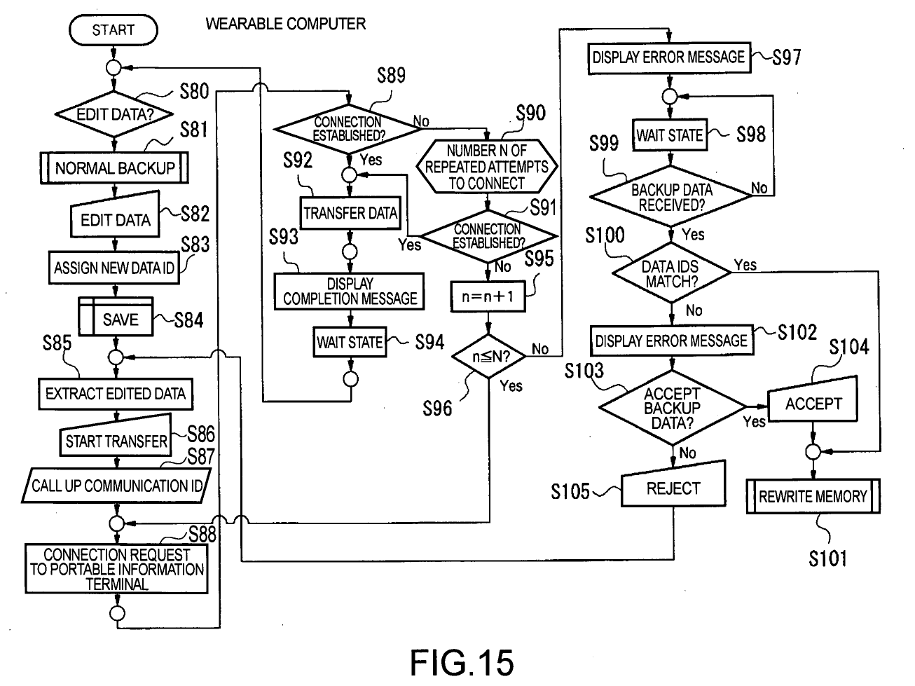

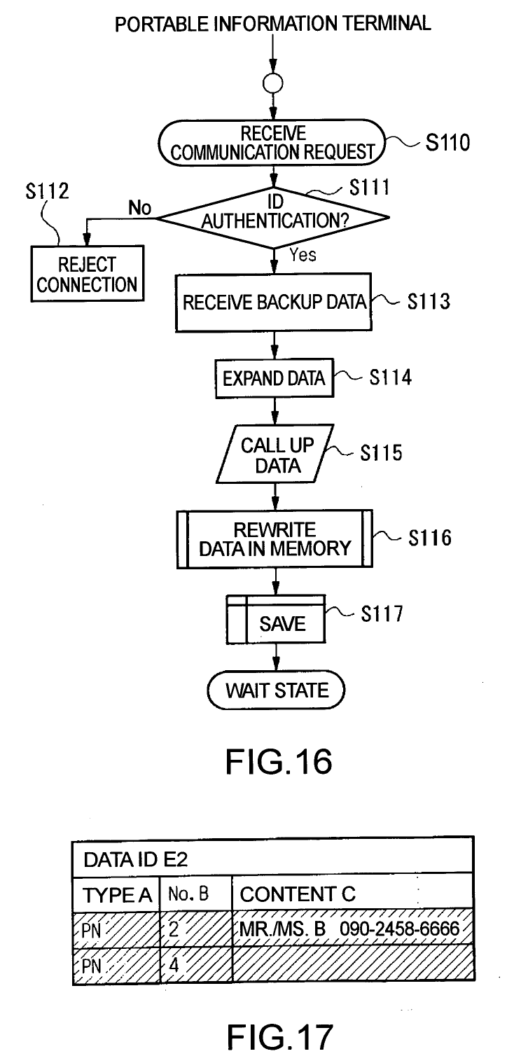

Next, the operations of the wearable computer and the portable information terminal, in a case where data in the wearable computer and data in the portable information terminal are synchronized when the user operates the wearable computer to edit phone-number data or mail-address data, will be described. FIGS. 15 and 16 are flowcharts showing a communication process that takes place when data is synchronized between the wearable computer and the portable information terminal in this exemplary embodiment.

When the user operates the switch unit 8 of the wearable computer to edit data (step S80 in FIG. 15), before entering a data editing mode in which the user is allowed to edit data, the CPU 1 executes processing in steps S60 to S74 shown in FIG. 14 to execute a normal backup process in which data is synchronized with the portable information terminal (step S81).

After the backup process, the CPU 1 enters the data editing mode, accepting input of results of data editing in accordance with the user's operation of the switch unit 8 (step S82), assigns a new data ID thereto (step S83), and writes the result to the ROM 2 (step S84).

Then, the CPU 1 reads only newly edited data from the ROM 2 (step S85), and starts a data transfer process (step S86). More specifically, the CPU 1 reads a communication ID (i.e., new ID code) that serves as a communication identifier from the ROM 2 (step S87), and sends a communication request with the communication ID attached thereto to the portable information terminal (step S88).

When the communication request from the wearable computer has been received by the portable information terminal (step S110 in FIG. 16), the CPU 31 executes ID authentication (step S111). That is, the CPU 31 reads a communication ID stored in advance in the ROM 32, and determines whether the new ID code attached to the communication request coincides with the communication ID stored in advance.

If these IDs match (Yes in step S111), the CPU 31 authenticates the wearable computer, and sends a signal that permits establishment of a connection to the wearable computer through the wireless communication unit 37.

However, if these IDs do not match (No in step S111), the CPU 31 rejects the connection (step S112).

When the connection-permitting signal from the portable information terminal has been received by the wearable computer through the wireless communication unit 7, the CPU 1 establishes a connection (Yes in step S89).

However, if a connection-permitting signal is not received within a predetermined length of time (No in step S89), the CPU 1 reads a value N representing a predetermined number of trials to connect (step S90). If the current number of trials to connect has not reached the value N, the CPU 1 again reads a communication ID (new ID code) that serves as a communication identifier from the ROM 2, and sends a communication request with the communication ID attached thereto to the portable information terminal.

When a connection has been established (Yes in step S91), the CPU 1 starts transfer of edit data (step S92).

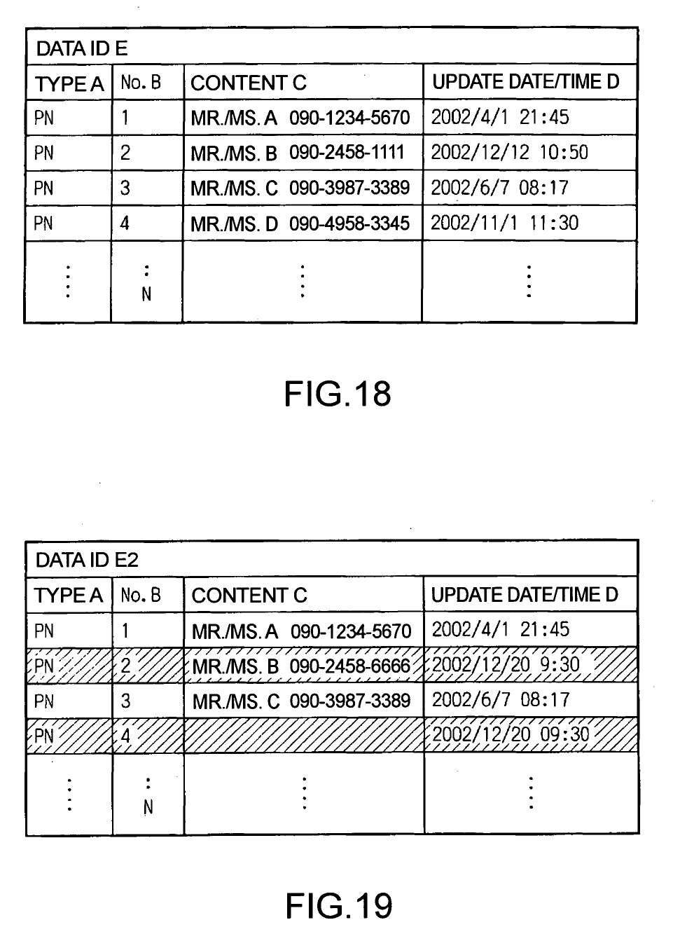

When the backup data (refer to FIG. 17) has been received by the portable information terminal (step S113 in FIG. 16), the CPU 31 expands the backup data (step S114), and determines whether or not to update data based on the backup data. That is, if the integrity of the backup data is verified, for example, by a CRC check on the expanded data, the CPU 31 reads the phone-number table (refer to FIG. 18) or the mail-address table stored in the ROM 32 (step S115), and starts a data updating process. More specifically, the CPU 31 checks whether in No. B of the backup data there is a match in No. B of the phone-number table or the mail-address table stored in the ROM 32. If a match is found, the CPU 31 overwrites the phone-number table in the ROM 32 using the backup data (steps S116 and S117).

In this exemplary embodiment, data updated on the data transfer date (9:30 on Dec. 20, 2002) is at No. B: 2, 4 (refer to FIG. 17), so that the CPU 31 modifies the phone-number-table data ID, content C, and update date/time D stored in the ROM 32.

When data transfer is completed in the manner described above, the CPU 1 displays a completion message on the display panel 4 (step S93), and returns to a wait state (step S94).

However, if a connection-permitting signal is not received within a predetermined length of time (No in step S91), the CPU 1 increments the value n representing the current number of trials to connect by one (step S95). If the value n, after the increment, representing the number of trials to connect is less than or equal to N (Yes in step S96), the CPU 1 repeats the processing in steps S88 to S93.

However, if the value n, after the increment, representing the number of trials to connect exceeds the value N (No in step S96), the CPU 1 displays an error message indicating a failure of connection on the display panel 4 (step S97), and returns to a wait state (step S98).

When the backup data from the portable information terminal has been received by the wearable computer in the wait state through the wireless communication unit 7 (step S99), the CPU 1 expands the backup data, and determines whether or not to update data based on the backup data. More specifically, if the completeness of the backup data is verified, for example, by a CRC check on the expanded data, the CPU 1 reads the phone-number table or the mail-address table stored in the ROM 2, and determines whether the data ID of the backup data matches the data ID in the phone-number table or the mail-address table (step S100).

However, if the backup data is corrupted, the CPU 1 quits the updating process, and erases and deletes the backup data.

If the data ID of the backup data matches the data ID in the phone-number table or the mail-address table stored in the ROM 2 (Yes in step S100), the CPU 1 starts a data updating process. Specifically, the CPU 1 checks whether in No. B of the backup data there is a match in No. B of the phone-number table or the mail-address table stored in the ROM 2. If a match is found, the CPU 1 overwrites the phone-number table or the mail-address table in the ROM 2 using the backup data (step S101).

However, if these data IDs do not match (No in step S100), the CPU 1 displays on the display panel 4 an error message to the effect that there is no correspondence with the edited data (step S102).

When the user operates the switch unit 8 to select acceptance of the backup data, the CPU 1, in response to input of an accepting command from the switch unit 8 (Yes in step S103), executes the same data processing as in the case where the data IDs match (steps S104 and S101).

However, when the user operates the switch unit 8 to select rejection of the backup data (No in step S103), in response to input of a rejecting command from the switch unit 8, the CPU 1 does not execute a data updating process (step S105).

As described above, with the wearable computer and the portable information terminal in the data backup system according to this exemplary embodiment, important data stored in the portable information terminal can be backed up on the wearable computer. Thus, for example, when original data in the portable information terminal becomes corrupted, the original data can be recovered immediately from the backup data.

Next, the operations of a wearable computer and a portable information terminal in an image-information transmission system according to an exemplary embodiment will be described with reference to the drawings.

The configurations of the wearable computer and the portable information terminal in this exemplary embodiment are the same as those in the data backup system described above, so that descriptions thereof will be omitted.

(2) Transmission of Image Information

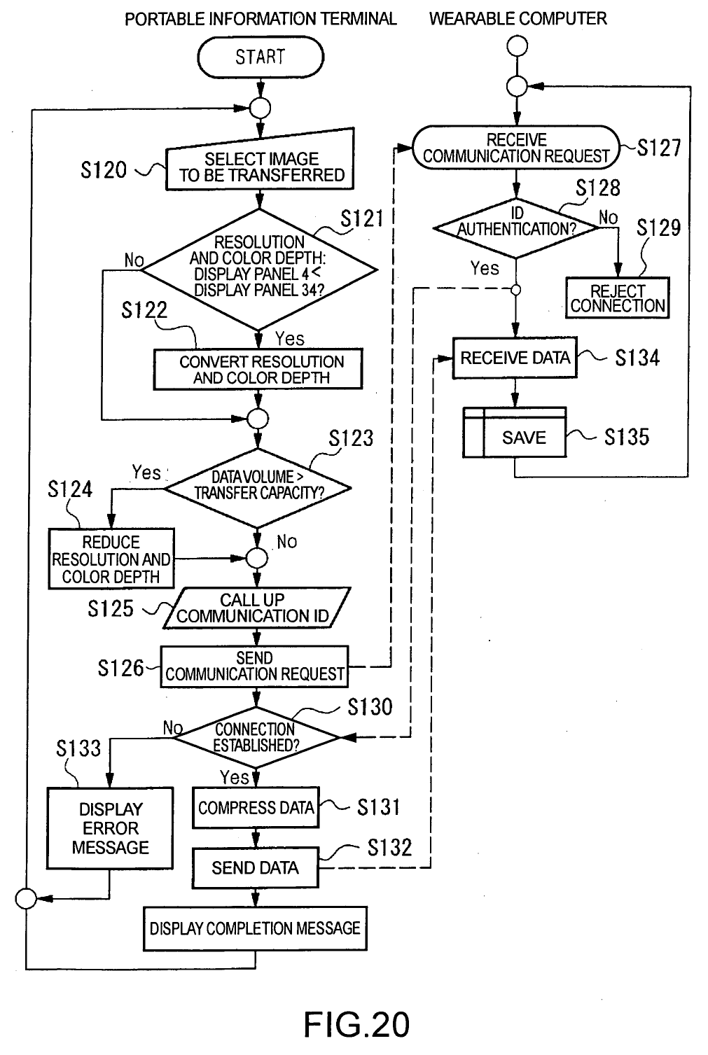

FIG. 20 is a flowchart showing the procedure of a process of transferring image information from the portable information terminal to the wearable computer in this exemplary embodiment.

At the portable information terminal, when the user operates the camera 35 to capture an image, the CPU 31 displays the image on the display 34. Then, when the user operates the switch unit 39 to select the image information displayed on the display 34 as an image to be transferred (step S120), if the settings of maximum resolution and color depth of the display panel 4 of the wearable computer, stored in advance in the ROM 32, are lower (or smaller) than the settings of maximum resolution and color depth of the display panel 34 (Yes in step S121), the CPU 31 converts the settings of maximum resolution and color depth of the image to be transferred into the settings of maximum resolution and color depth of the display panel 4 of the wearable computer (step S122), for example cubic convolution interpolation, dither method.

However, if the settings of maximum resolution and color depth of the display panel 4 are higher (or larger) than the settings of maximum resolution and color depth of the display panel 34 (No in step S121), the CPU 31 does not execute conversion of the resolution and the color depth.

If the data volume of the image to be transferred exceeds a predetermined upper limit of volume of data to be transferred (No in step S123), the CPU 31 reduces the resolution and color depth of the image to be transferred (step S124)), for example cubic convolution interpolation, dither method.

However, if the data volume of the image to be transferred is within the upper limit (Yes in step S123), the CPU 31 does not reduce the resolution and color depth of the image to be transferred.

Then, the CPU 31 reads a communication ID (old ID code) that serves as a communication identifier, from the ROM 32 where it is stored in advance (step S125), and sends a communication request with the communication ID attached thereto to the wearable computer (step S126).

At this time, the CPU 31 generates a new ID code as a communication ID that is to be used for a next session of communication with the wearable computer, attaches the new ID code as well as the old ID code to the communication request, and sends the communication request through the wireless communication unit 37.

When the communication request from the portable information terminal has been received by the wearable computer through the wireless communication unit 7, the CPU 1 executes ID authentication. Specifically, the CPU 1 reads a communication ID stored in advance in the ROM 2, and checks whether the old ID code attached to the communication request coincides with the communication ID (step S128).

If these IDs match, the CPU 1 authenticates the portable information terminal, sends a signal that permits establishment of a connection to the portable information terminal through the wireless communication unit 7, and writes the new ID code attached to the communication request to the ROM 2.

However, if the communication ID and the old ID code do not match, the CPU 1 does not authenticate the wearable computer, rejecting connection (step S129).

When the connection-permitting signal from the wearable computer has been received by the portable information terminal through the wireless communication unit 37, the CPU 31 establishes a connection (Yes in step S130).

The CPU 31 then compresses the image transferred (step S131), sends the compressed image to the wearable computer through the wireless communication unit 37 (step S132), and displays a completion message on the display panel 34.

However, if a connection-permitting signal is not received within a predetermined length of time (No in step S130), the CPU 31 displays on the display panel 34 an error message indicating a failure of connection (step S133).

When the image to be transferred (image information) from the portable information terminal has been received by the wearable computer through the wireless communication unit 7 (step S134), the CPU 1 expands the image, and writes the expanded image to the ROM 2 (step S135), and displays the expanded image on the display panel 4.

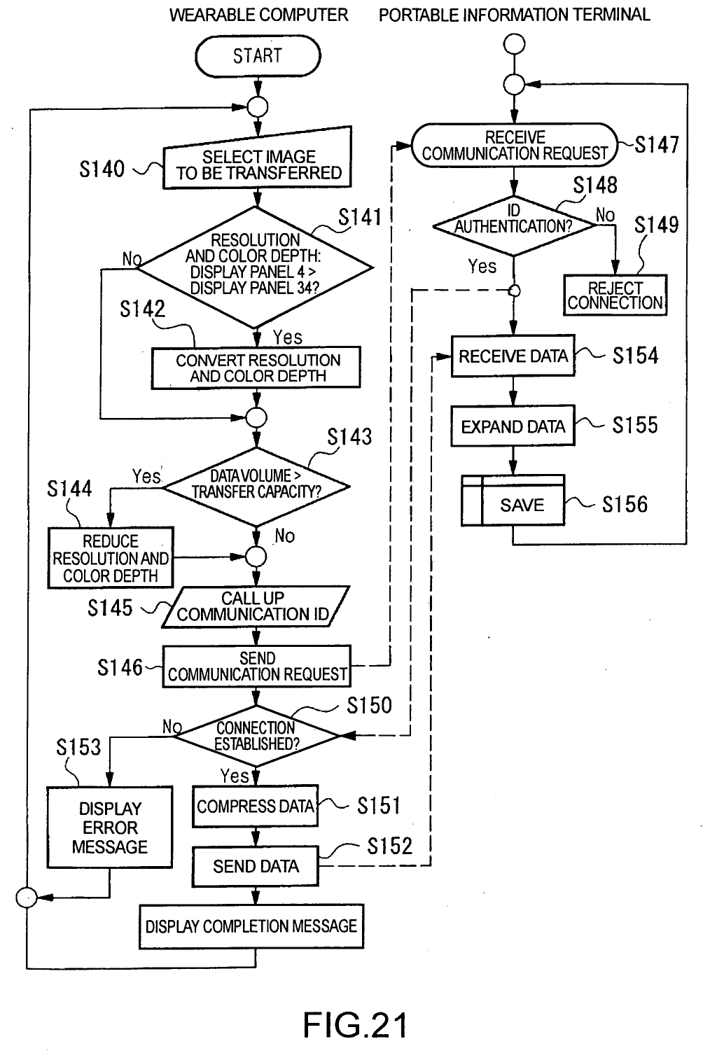

Next, the operations of the wearable computer and the portable information terminal in a case where image information is transmitted from the wearable computer to the portable information terminal will be described. FIG. 21 is a flowchart showing the procedure of a process for transferring image information from the wearable computer to the portable information terminal in this exemplary embodiment.

At the wearable computer, when the user operates the camera 5 to capture an image, the CPU 1 displays the image on the display panel 4. Then, when the user operates the switch unit 8 to select the image information displayed on the display panel 4 as an image to be transferred (step S140), if the settings of maximum resolution and color depth of the display panel 34 of the portable information terminal stored in advance in the ROM 3 are lower (or smaller) than the settings of maximum possible resolution and color depth of the display panel 4 (No in step S141), the CPU 1 converts the settings of maximum resolution and color depth of the image to be transferred into the settings of maximum resolution and the color depth of the display panel 34 of the portable information terminal (step S142)), for example cubic convolution interpolation, dither method.

However, if the settings of maximum resolution and the color depth of the display panel 4 are higher (or larger) than the settings of maximum resolution and the color depth of the display panel 34 (Yes in step S141), the CPU 1 does not convert the resolution or the color depth.

If the data volume of the image to be transferred exceeds a predetermined upper limit of the volume of data to be transferred (No in step S143), the CPU 1 further reduces the resolution and color depth of the image to be transferred (step S144)), for example cubic convolution interpolation, dither method.

However, if the data volume of the image to be transferred is within the upper limit (Yes in step S143), the CPU 1 does not reduce the resolution or color depth of the image to be transferred.

Then, the CPU 1 reads a communication ID (new ID code) that serves as a communication identifier from the ROM 2 where it is stored in advance (step S145), and sends a communication request with the communication ID attached thereto to the portable information terminal (step S146).

When the communication request from the wearable computer has been received by the portable information terminal through the wireless communication unit 37 (step S147), the CPU 31 executes ID authentication. More specifically, the CPU 31 reads a communication ID stored in advance in the ROM 32, and checks whether the new ID code attached to the communication request coincides with the communication ID (step S148).

If these IDs match, the CPU 31 authenticates the wearable computer, and sends a signal that permits establishment of a connection to the wearable computer through the wireless communication unit 37.

However, if the communication ID and the new ID code do not match, the CPU 31 does not authenticate the wearable computer, rejecting connection (step S149).

When the connection-permitting signal from the portable information terminal has been received by the wearable computer through the wireless communication unit 7, the CPU 1 establishes connection (Yes in step S150).

The CPU 1 then compresses the image to be transferred (step S151), sends the compressed image to the portable information terminal through wireless communication unit 7 (step S152), and displays a completion message on the display panel 4.

However, if a connection-permitting signal is not received within a predetermined length of time (No in step S150), the CPU 1 displays on the display panel 4 an error message indicating a failure of connection (step S153).

When the image to be transferred (image information) from the wearable computer has been received by the portable information terminal through the wireless communication unit 37 (step S154), the CPU 31 expands the image (step S155), writes the expanded image to the ROM 32 (step S156), and displays the expanded image on the display panel 34.

As described above, with the image-information transmission system according to this exemplary embodiment, image data of a large volume can be backed up even in a wearable computer having a restricted capacity of data storage or data transfer. Furthermore, when a user wishes to view an image captured by a camera of a cellular phone, the image can be viewed on a wearable computer even if not on display of a portable information terminal.

Next, the operations of a wearable computer and a portable information terminal in a mail transmission system according to an exemplary embodiment will be described with reference to the drawings.

The configurations of the wearable computer and the portable information terminal in this exemplary embodiment are the same as those in the data backup system described above, so that descriptions thereof will be omitted.

(3) Mail Transmission

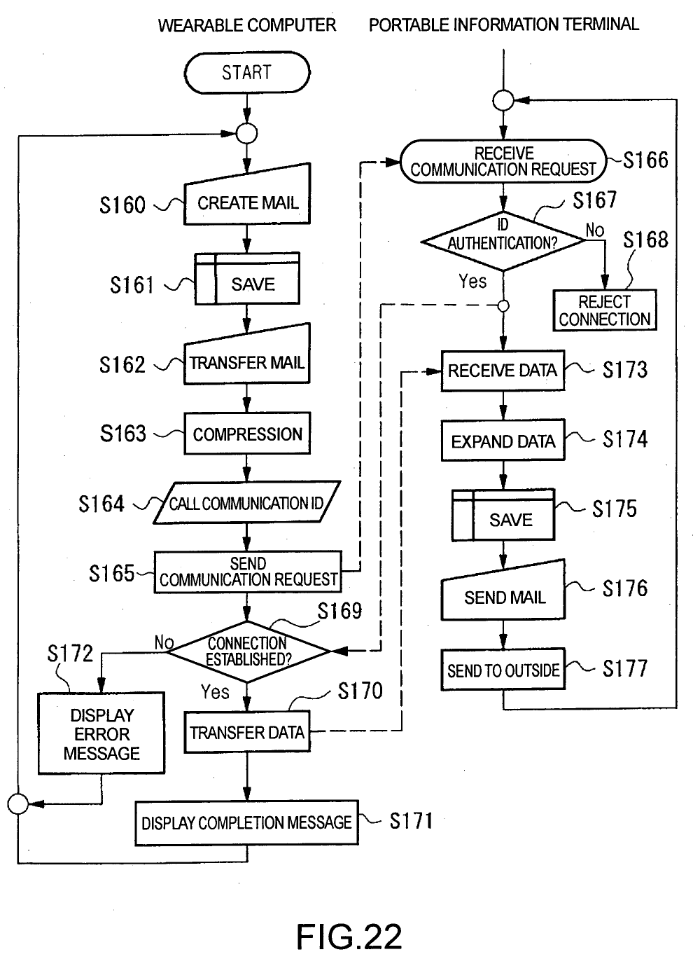

FIG. 22 is a flowchart showing the procedure of a mail transmission process executed between the wearable computer and the portable information terminal in this exemplary embodiment.

When a user operates the switch unit 8 of the wearable computer to create or edit a mail (step S160 in FIG. 22), the CPU 1, in response to input of a result of editing of the mail through a user's operation of the switch unit 8, writes it in the ROM 2 (step S161).

Then, the CPU 1 starts a process of transferring the edited mail data (step S162). More specifically, the CPU 1 compresses the mail data (step S163), reads a communication ID (new ID code) that serves as a communication identifier from the ROM 2 (step S164), and sends a communication request with the communication ID attached thereto to the portable information terminal (step S165).

When the communication request from the wearable computer has been received by the portable information terminal (step S166), the CPU 31 executes ID authentication. That is, the CPU 31 reads a communication ID stored in advance in the ROM 32, and checks whether the new ID code attached to the communication request coincides with the communication ID stored in advance (step S167).

If these IDs match (Yes in step S167), the CPU 31 authenticates the wearable computer, and sends a signal that permits establishment of a connection to the wearable computer through the wireless communication unit 37.

However, if these IDs do not match (No instep S167), the CPU 31 rejects connection (step S168).

When the connection-permitting signal from the portable information terminal has been received by the wearable computer through the wireless communication unit 7, the CPU 1 establishes a connection (Yes in step S169), and starts transfer of the compressed mail data (step S170). When the transfer of the data to the portable information terminal has been completed, at the wearable computer, the CPU 1 displays a completion message on the display panel 4 (step S171), and returns to a Wait state.

However, if a connection-permitting signal is not received within a predetermined length of time (No in step S169), the CPU 1 displays on the display panel 4 an error message indicating a failure of connection (step S172), and returns to a wait state.

When the compressed mail data has been received by the portable information terminal (step S173), the CPU 31 expands the compressed mail data (step S174), and writes the expanded data to the ROM 32 (step S175).

Then, when a command for mail transmission is input by a user's operation of the switch unit 39, the CPU 31 connects to an external network, such as the Internet, through the portable-terminal-communication transmitter/receiver 38, and sends the expanded mail data to the destination address indicated by the expanded mail data (step S176 and S177).

When the transfer of the data between the wearable computer, and the portable information terminal has been completed in the manner described above, at the wearable computer, the CPU1 displays a completion message on the display panel 4 (step S171), and returns to a wait state.

As described above, with the mail transmission system according to this exemplary embodiment, mail can be created or edited on a wearable computer, and mail data can be transmitted via a portable information terminal having an interface to connect to an external network.

3. Modifications

The present invention is not limited to the exemplary embodiments described above. Various modifications including modifications described below are possible, all of which falling within the scope of the present invention.

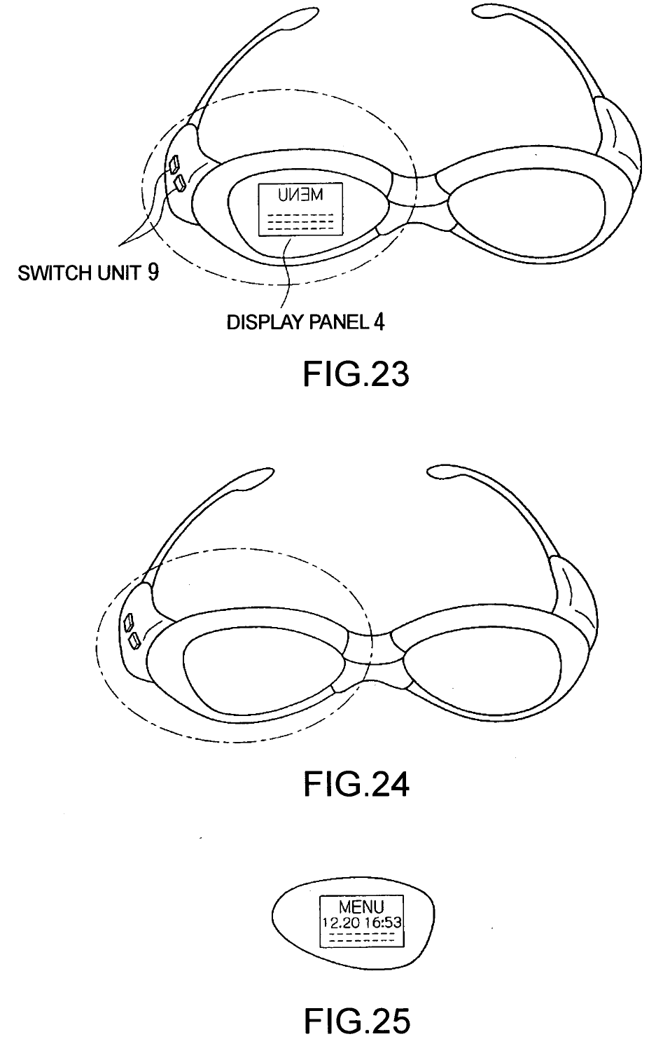

The exemplary embodiments have been described in the context of a wearable computer that is worn on a sleeve of clothes, such as a suit. However, the present invention is not limited thereto. As described earlier, the present invention can be applied, for example, to a watch, glasses, a pendant, a ring, a hat, a bracelet, or clothes. For example, if a wearable computer according to an aspect of the present invention is applied to glasses, the switch unit described above is provided at a junction of a rim and a temple of the glasses, and a display panel is provided on the lens of the glasses, as shown in FIG. 23.

The display panel may be integrated with the glasses, or detachable as shown in FIGS. 24 and 25, allowing the frame of the glasses to be separated.

The procedures of the series of processes relating to data backup, the series of processes relating to mail transmission, the series of processes relating to image transmission, and so forth, are stored in a computer-readable recording medium in the form of programs. The processes are executed by a computer reading and executing the programs.

The programs to achieve the functions of the processing units to execute the processes may be implemented respectively by separate programs modules, or by an integrated program module.

The entirety or a part of the functions may be implemented in hardware using logic circuits.

The program modules may be run as part of an existing application program, or as independent programs.

The computer programs may be distributed to a computer via a communication circuit, allowing the computer to execute the programs.

The “computer-readable recording medium” refers to a storage device, for example, a portable medium, such as a flexible disk, a magneto-optical disk, a ROM, or a CD-ROM, or a hard disk or a hard disk included in a computer server. Furthermore, the “computer-readable recording medium” may also refer to a device that holds the program for a certain period, such as a volatile memory (RAM) in a computer server that acts as a server or a client when the programs are transmitted through a network, such as the Internet, or a communication line, such as a telephone circuit.

The programs may be transmitted from a computer server including a storage device storing the program to another computer server by way of a transmission medium or by transmission waves in the transmission medium. The “transmission medium” herein refers to a medium that is capable of transmitting information, for example, a network (communication network), such as the Internet or a communication line, such as a telephone circuit.

The programs may serve only to achieve part of the functions described above. Also, the programs may be difference files (difference programs) that achieve the functions described above in cooperation with programs already recorded in the computer server.

What is claimed is:

1. A data backup system, comprising:
a wearable computer including a receiving device to receive backup data and a backup-data writing device to write the backup data to a second storage device; and
a portable information terminal that carries out data communication with the wearable computer; the portable information terminal including,
a first storage device to store predetermined data, a history of updates of the data, and a history of backups of the data and
an extracting device to read the update history and the backup history from the first storage device, compare the time of the last backup indicated by the backup history with the time of the last update indicated by the update history, search for data newly updated since the time of the last backup, extract the newly updated data as the backup data, and a data sending device to send the backup data extracted.

2. The data backup system according to claim 1,
the portable information terminal further comprising:
a data compressing device to compress the backup data, and the sending device sends the compressed backup data,
and the wearable computer further comprises:
a data expanding device to expand the compressed backup data received by the receiving device.

3. The data backup system according to claim 1,
the predetermined data and the backup data each including an identifier representing the predetermined data,
and the backup-data writing device compares an identifier of backup data stored in advance in the second storage device with an identifier of the backup data received, and writes the backup data received in the second storage device when these identifiers coincide with each other.

4. The data backup system according to claim 1,
the first storage device further storing in advance a predetermined communication identifier,
the sending device sending a communication-connection request using the communication identifier,
and the wearable computer further comprising:
an authenticating device to compare a communication identifier received by the receiving device with a Communication identifier stored in advance in the second storage device, and permitting connection by the portable information terminal when these identifiers coincide with each other.

5. A wearable computer that carries out data communication with a portable information terminal, comprising:
a first receiving device to receive a communication identifier of the portable information terminal from the portable information terminal;
an authenticating device to compare the communication identifier received with a communication identifier stored in advance in predetermined storage device, and permitting connection by the portable information terminal when these identifiers coincide with each other;
a second receiving device to receive backup data from the portable information terminal when connection has been permitted by the authenticating device; and
a backup-data writing device to write the backup data in the storage device.

6. A mail transmission system, comprising:
a wearable computer including an input device to receive input of mail information, a data compressing device to compress the mail information that has been input and a first sending device to send the compressed mail information to the portable information terminal; and
a portable information terminal that carries out data communication with the wearable computer, including a receiving device to receive the compressed mail information, a data expanding device to expand the compressed mail information received and a second sending device to send the expanded mail information to a destination address indicated by the mail information.

7. An image-information transmission system, comprising:
a wearable computer including an input device to receive input specifying image data to be transmitted, a data compressing device to compress the image data if the amount of the image data specified is greater than or equal to a predetermined threshold and a sending device to send the compressed image data; and
a portable information terminal that carries out data communication with the wearable computer, the portable information terminal including a receiving device to receive the compressed image data, a data expanding device to expand the compressed image data received and an image-data writing device to write the expanded image data in a predetermined storage device.

8. An image-information transmission system, comprising:
a wearable computer including a receiving device to receive the compressed image data and an image-data writing device to write the compressed image data in a predetermined storage device; and
a portable information terminal that carries out data communication with the wearable computer, the portable information terminal including an input device to receive input specifying image data to betransmitted, a data compressing device to compress the image data if the amount of the image data specified is greater than or equal to a predetermined threshold and a sending device to send the compressed image data.

9. A data backup method to back up data in a data backup system including a wearable computer and a portable information terminal that carries out data communication with the wearable computer, comprising:
the portable information terminal,
reads from a first storage device that stores predetermined data, the history of updates of the data, and the history of backups of the data,
compares the time of the last backup indicated by the backup history with the time of the last update indicated by the update history,
searches for data newly updated since the time of the last backup,
extracts the newly updated data as backup data, and
sends the backup data extracted; and
the wearable computer,
receives the backup data, and
writes the backup data in a second storage device.

10. A data backup program causing a wearable computer to execute a data backup process, backing up data in a data backup system including the wearable computer and a portable information terminal that carries out data communication with the wearable computer, the data backup process, comprising:
receiving a communication identifier of the portable information terminal from the portable information terminal;
comparing the communication identifier received with a communication identifier stored in advance in a predetermined storage device, and permitting connection by the portable information terminal when these identifiers coincide with each other;
receiving backup data from the portable information terminal when connection has been permitted by an authenticating process authentication device; and
writing the backup data in the predetermined storage device.
